(19) United States
(12) Patent Application Publication
(10) Pub. No.: US 2007/0204169 A1
(43) Pub. Date: Aug. 30, 2007

(54) Enabling automatic business processes using state transfer diagram and abstraction

(75) Inventors: Amarjit S. Bahl, Brookfield, CT (US); Dikran S. Meliksetian, Danbury, CT (US); Nianjun Zhou, Danbury, CT (US)

Correspondence Address: John E. Campbell, IBM Corporation, 2455 South Road, P386, Poughkeepsie, NY, 12601, US

(73) Assignee: International Business Machines Corporation, Armonk, NY (US)

(21) Appl. No.: 11/364,376

(22) Filed: Feb. 28, 2006

(51) Int. Cl. G06F 12/14

(52) U.S. Cl. 713/189

(57) ABSTRACT

An application specific framework is generated from configuration information contained in a configuration file. The application specific framework comprises a state transformation diagram. Application specific plug-in code is generated from the configuration information for attaching application programs to the framework. External events trigger navigation of the state transformation diagram according to rules derived from user profile and user state information. Navigation of the state transformation exercises function of the attached application programs. Modification of the function of the framework is accomplished by simply modifying the configuration information as needed.

### FIELD OF THE INVENTION

The present invention relates to the field of computer implemented business process automation and more particularly to abstraction of business logic for business process automation.

### BACKGROUND OF THE INVENTION

Various techniques have been made to influence consumer behavior to stimulate purchases. Typically, these techniques offer discounts or other incentives to consumers on goods and services which are to be promoted. For example, printed coupons offering discounts on promoted products may be distributed to consumers and may be redeemed by the consumers when a consumer purchases the promoted product preferably at the point-of-sale (POS). These coupons are generally distributed to consumers in a random manner or in a more demographically focused manner, e.g. via blanket mailings to residents of a neighborhood or region. A major drawback of this method of distribution is that the coupons are not targeted to consumers most likely to use the coupons. This often results in consumers receiving coupons which are irrelevant and uninteresting to the consumers.

Loyalty cards have been introduced which enable computer implemented point-of-sale systems to capture consumer purchase history information related to purchases made by the consumer. By basing the distribution of coupons upon the consumer purchase history information, retailers and manufacturers have had better success in targeting potential purchasers of a particular product. Additionally, the distribution may be based upon demographic information provided by the consumer when applying for the loyalty card. Retailers and/or manufacturers are now able to target potential purchasers for a product by executing simple database queries (e.g. “People who buy Product X more than twice per week and who spend more than $30 per month at a store”) against the captured information. Consumers who match the query criteria then receive an incentive offer or coupon on a product associated with the query criteria.

US Patent Application No. 2001/0032128 A1: “Techniques for optimizing promotion delivery” (Kepecs) filed Dec. 22, 2000 and incorporated herein by reference provides management of promotion functions in a marketing system, and techniques for generating offers to a consumer with a view towards influencing the consumer's purchasing behavior. The application describes a business process need but fails to provide an easy to use computer system infrastructure for such a process.

US Patent Application No. 2001/0032128 A1: “Techniques for optimizing promotion delivery” (Kepecs) filed Dec. 22, 2000 and incorporated herein by reference provides techniques for generating and making incentive offers and promotions to consumers to influence the consumers' purchasing behavior. Offers are customized for each individual consumer based on the particular consumer's purchase history information (or shopping history) and the consumer's response to the offers.

In one embodiment of Kepecs, information is received identifying a plurality of consumers. The embodiment also receives purchase history information for the plurality of consumers which comprises information related to purchases made by the plurality of consumers. A first consumer is identified from the plurality of consumers based upon the purchase history information and the information identifying the plurality of consumers. A first offer is generated for the first consumer and provided to the first consumer. The first offer offers a first product for purchase by the first consumer at a first price for a first time period. A determination is made if the first consumer purchased the first product at the first price during the first time period, and generates a second offer for the first consumer such that: if the first consumer purchased the first product at the first price during the first time period, the second offer offers the first product for purchase by the first consumer at a second price for a second time period, wherein the second price is greater than or equal to the first price, and, if the first consumer did not purchase the first product at the first price during the first time period, the second offer offers-the first item at a third price for a third time period, wherein the third price is less than the first price. The generation of offers is controlled using a state machine.

Kepecs employs a specific state machine infrastructure but does not provide a generalized enabling framework.

US Patent Application No. 2002/0129345 A1: “SCRIPTING BUSINESS LOGIC IN A DISTRIBUTED OBJECT ORIENTED ENVIRONMENT” (Tilden et al.) filed Sep. 27, 2001 and incorporated herein by reference provides a distributed object oriented software system that it is customizable and flexible enough to implement a wide variety of different “business logics” without the need to rewrite the basic components of the software system because it provides scripting capability in a distributed object-oriented software system. The Tilden application includes a rules-based scripting language that can be interpreted by a Rules Engine that is part of the base class of component for the software system. In accordance with the present invention each individual component of the software system may have one or more predetermined rule sets defined for it. Each predetermined rule set allows customization of the behavior of the associated component of the software system.

The Tilden application provides a scripting approach to implementing customized performance of software components in a distributed objected-oriented software system.

According to Tilden an individual component of the software system may have one or more predetermined rule sets defined for it. If any component does not have a predetermined rule set defined for it then the component will run according to its own internal program. If a single predetermined rule set is listed, and the component is built to process a predetermined rule set through a Rules Engine in accordance with the present invention, then the single predetermined rule set will be used for every call to the component's general purpose operation (e.g. Controller's do_operation, Modifier's modify, Validator's validate, etc.). If a plurality of predetermined rule sets is listed for a particular component, then that component will make a controllable runtime decision as to which predetermined rule set of the plurality of predetermined rule sets will be applied, usually by attempting to match the name of each predetermined rule set of the plurality of predetermined rule sets to a special instructions parameter passed in to the component when it was instantiated and using whichever predetermined rule set of the plurality of predetermined rule sets corresponds to the special instruction parameter.

U.S. Pat. No. 6,105,059: “Programming information for servers and clients in a distributed computing environment using stub codes with event information for a debugging utility” filed Dec. 16, 1996 incorporated herein by reference discloses an example programming use of “stub code”.

U.S. Pat. No. 6,546,551: “Method for accurately extracting library-based object-oriented applications” filed Sep. 28, 1999 incorporated herein by reference discloses an example programming use of “reflection”.

These techniques fail to take into consideration an individual consumer's unique shopping preferences which are not truly represented by either the segment in which the consumer is classified or by the query criteria. Further, the above-mentioned techniques fail to take into consideration the individual consumer's historical response to the incentives or offers.

Besides the commercial applications discussion above, large corporations focus on employee retention and providing valued added services for employee satisfaction of various schemes and policies defined by the corporate Human Resources organization (HR). These policies are blanket policies that cover everyone whether they are interested in it or not. For many employees the new scheme may not be relevant due to the geography or the lifestyles in which they live. To achieve real employee satisfaction the corporation would advantageously provide personalized services to the employees to cater to their individual needs. But for large organizations (some with hundreds of thousands of employees) this may pose an HR challenge due to the number of people required to track each employee's personal needs and devise programs for them.

In light of the above, for commercial application, there is a need for consumer marketing techniques which achieve one-to-one marketing and customize offers for each individual consumer based on the particular consumer's purchase history information (or shopping history) and the consumer's response to the offers. For corporations there is a need for a system that can track the employee's previous preference and provide future suggestion on based on the employee's history of selecting the services.

Furthermore, applications developed for different industries have very different specifications, functionalities and requirements. This is true even for the applications in the same industry but different vendors. Therefore, applications are dramatically different in functionality and implementation from one to another. Typical solution to any e-business application is to develop an application specific model using a three-tier infrastructure. The logic (code) is embedded in the application layer along with the application specific repository (such as database or LDAP). It is desirable that the implementation of these marketing/corporate services be easy to with minimum re-coding effort and flexible to modify the function if needed.

Using this model of application development, making changes to the business logic or the flow is not very easy, or flexible and often requires a major re-coding effort.

### SUMMARY OF THE INVENTION

The present invention relates to the field of automation of commercial processes for e-business applications requiring satisfying a customer-specific needs or promotions. It is more particularly related to the abstraction of the business logic as a configurable state-transfer diagram and applying the business-specific plug-in model using reflection to achieve the goals of business automation, and code reuse. The configurable architecture can help us avoid the needs of having frequent application code changes. This methodology is also applicable for non-commercial applications required from organizations to provide personalized services based on their members or employees special needs or service usage history.

In one aspect of the invention, in order to create a flexible business automation application, it is desirable to provide certain levels of abstraction and the separation of the logic and code implementation to minimize the risk of having to recode applications. The abstraction will bring benefits for the development team as well as management and reduce the development cost and increase the efficiency of the whole application development process. In certain applications the logic change could be as simple as making some changes to the configuration file without any code change.

In another aspect of the present invention automation is provided of a special class of e-business applications preferably sharing the following common features:
First, the application is designed for many customers or end-users;
Second, each customer has his/her own profile and all necessary customer information relevant to the business is recorded; and
third, any targeted promotions/events are based on the customer's profile.

The end-users of the business process are preferably either customers or business partners. In the present specification, we will use the term end-user and customer inter-changeably.

In a novel aspect of the invention, a methodology and framework are provided to allow people to develop applications for business automation over virtual business process environment. The framework is built upon the concept of an abstract state-transformation machine and computational reflection. Computational reflection is a computer process involving self-awareness. A reflective program has the ability to meta-program (it can, itself, write programs). Our virtual business process captures the major features of many other business operations. By using this framework, we can have more flexibility and reuse of code. Advantageously, the framework is preferably customized for a specific application by creating configuration file information in a simple script language such as XML. Application programs are attached to the Framework via plug-in code generated from information contained in the configuration file.

Referring to FIGS. 7 and 8, it is therefore, an object of the invention to provide a computer implemented method for generating an application specific framework 705, the method comprising: obtaining 703 configuration information from a configuration file 702, the configuration information comprising a state transformation diagram 704 for the application specific framework 705; deriving application specific plug-in code 711 from the obtained configuration information 703, the application specific plug-in code 711 comprising functions for supporting application specific requirements; creating the application specific framework 705 from framework information comprising the obtained configuration information 703 and the derived application specific plug-in code 711; the created application specific framework 705 obtaining user specific information 706 about one or more users 714, the user specific information 706 comprising profile information 708 about a respective user and current user state 707 of the respective user; the created application specific framework 705, responsive to an external event 713, navigating 802 the state transformation diagram 716 from the current user state 804 to a new current user state 804, the navigation based on the user specific information 706; and saving the new current user state 804 as the current user state 804; responsive to the navigating step 802 invoking a corresponding function via the derived application specific plug-in code 711.

It is another object of the invention to derive application specific plug-in code 711 by parsing 709 the configuration information to create stub code 710 for interfacing the application specific framework 705 with one or more application programs 712; and then implementing the stub code 710 as the application specific plug-in 711 using the programming language of the stub code 710.

It is yet another object of the invention to, responsive to an external event 713, select the new current user state 804 from a plurality of user states 804 based on any one of the current user state 804, the external event 713 or the configuration information 703.

It is still another object of the invention to create 701 the configuration information 701 comprising any one of external event definitions 715 or the state transformation diagram 716; and then save the configuration information in the configuration file 702.

It is a further object of the invention to provide external event definitions 715 comprising event trigger points, the event trigger points comprising critical thresholds 717.

It is another object of the invention, to provide an obtained state transformation diagram 704 comprising a directed graph having a set of logic vector array values, the logic vector array values presenting a vertex of the graph of the obtained state transformation diagram.

It is a further object of the invention to provide a obtained configuration file information 703 comprising XML.

It is a further object of the invention to present a user state 707 as a current logic vector array Boolean value presented by a vertex of the application specific state transformation diagram 704, wherein the navigating 802 the state transformation diagram 704 step comprises the further step of executing functions 803 specified by a name of an edge of the state transformation diagram 704 in the plug-in code 711.

It is a further object of the invention to determine a relationship of attributes 805 of the profile information; and to provide the determined relationship of attributes as the user specific information 706 for the navigation step 802.

It is a yet another object to create any one of Java stub code, C++ stub code or a general-purpose language selected for creating the plug-in code 711.

It is a further object of the invention to provide a user 714 comprising any one of a GUI interface to a human user 806, a computer program responding to a mechanical event 807, or a computer program responding to a program event 808.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram depicting the components of a computer system;

FIG. 2 is a depiction of a prior art Client/Server network;

FIG. 3 depicts an example architecture of the framework of an embodiment of the system;

FIGS. 4A-4B depicts an example collective state transfer diagram for implementing a Refer-a-friend system;

FIG. 5 represents an example of the application independent state storage data source;

FIG. 6 is an example graphical form of the XML schema, which is used to specify the format of configuration file in XML format

FIG. 7 is an example flow diagram for generating an Application Specific Framwork; and

FIG. 8 is an example flow diagram of the operation of the Application Specific Framework.

The detailed description explains the preferred embodiments of the invention, together with advantages and features, by way of example with reference to the drawings.

### DESCRIPTION OF PREFERRED EMBODIMENTS

In the following description of preferred embodiments of the present invention, numerous specific details are set forth in order to provide a thorough understanding of the present invention. However, it will be obvious to one skilled in the art that the present invention may be practiced without these specific details. In other instances well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, step, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

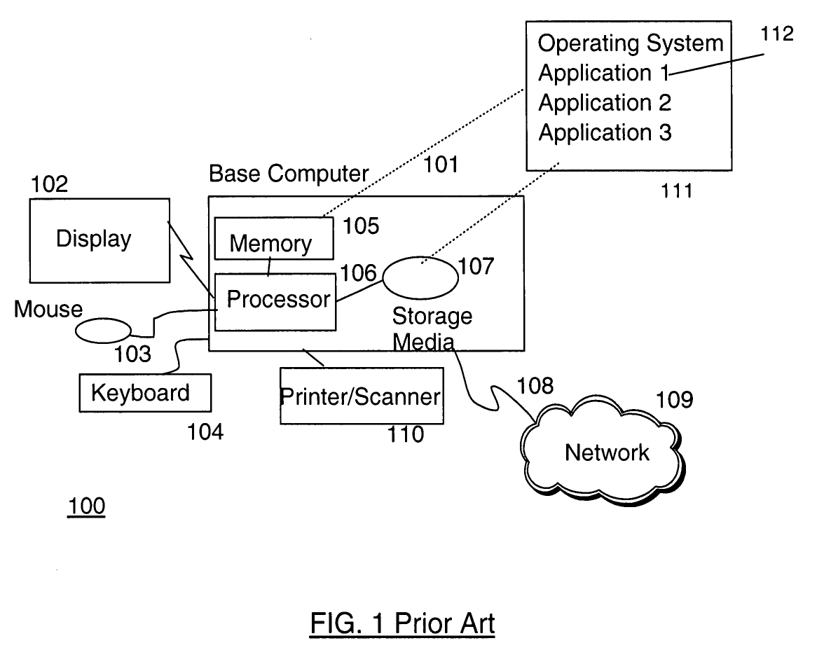

FIG. 1 illustrates a representative workstation or server hardware system in which the present invention may be practiced. The system 100 of FIG. 1 comprises a representative computer system 101, such as a personal computer, a workstation or a server, including optional peripheral devices. The workstation 101 includes one or more processors 106 and a bus employed to connect and enable communication between the processor(s) 106 and the other components of the system 101 in accordance with known techniques. The bus connects the processor 106 to memory 105 and long-term storage 107 which can include a hard drive, diskette drive or tape drive for example. The system 101 might also include a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter.

The system 101 may communicate with other computers or networks of computers by way of a network adapter capable of communicating with a network 109. Example network adapters are communications channels, token ring, Ethernet or modems.

Alternatively, the workstation 101 may communicate using a wireless interface, such as a CDPD (cellular digital packet data) card. The workstation 101 may be associated with such other computers in a Local Area Network (LAN) or a Wide Area Network (WAN), or the workstation 101 can be a client in a client/server arrangement with another computer, etc. All of these configurations, as well as the appropriate communications hardware and software, are known in the art.

The system 101 may communicate with other computers or networks of computers by way of a network adapter capable of communicating with a network 109. Example network adapters are communications channels, token ring, Ethernet or modems. Alternatively, the workstation 101 may communicate using a wireless interface, such as a CDPD (cellular digital packet data) card. The workstation 101 may be associated with such other computers in a Local Area Network (LAN) or a Wide Area Network (WAN), or the workstation 101 can be a client in a client/server arrangement with another computer, etc. All of these configurations, as well as the appropriate communications hardware and software, are known in the art.

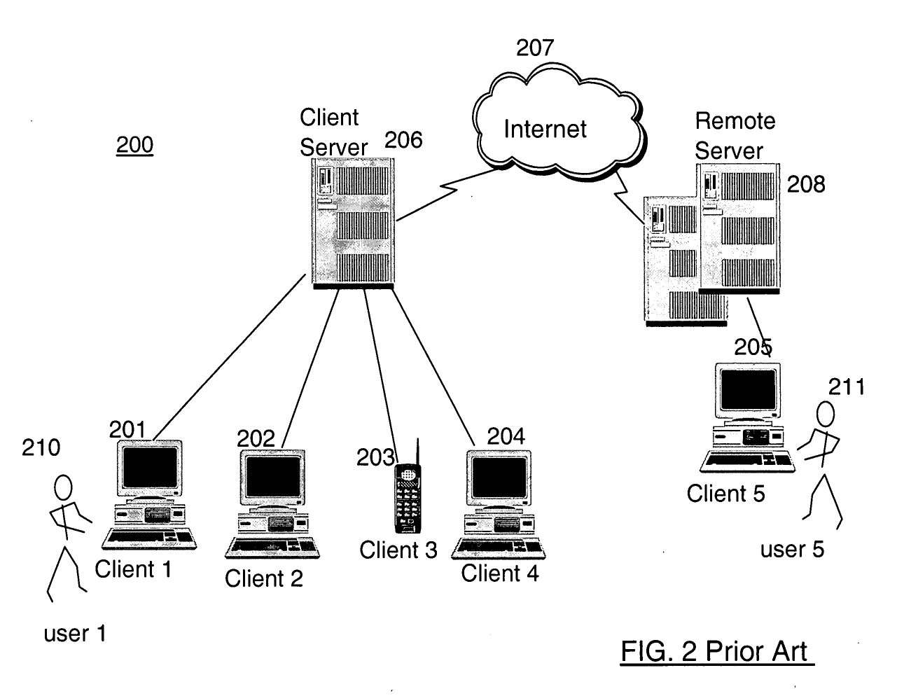

FIG. 2 illustrates a data processing network 200 in which the present invention may be practiced. The data processing network. 200 may include a plurality of individual networks, such as a wireless network and a wired network, each of which may include a plurality of individual workstations 101. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206 ) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an IBM eServer zSeries® 900 Server available from IBM Corp.

Software programming code which embodies the present invention is typically accessed by the processor 106 of the system 101 from long-term storage media 107, such as a CD-ROM drive or hard drive. The software programming code may be embodied on any of a variety of known media for use with a data processing system, such as a diskette, hard drive, or CD-ROM. The code may be distributed on such media, or may be distributed to users from the memory or storage of one computer system over a network to other computer systems for use by users of such other systems.

Alternatively, the programming code 111 may be embodied in the memory 105, and accessed by the processor 106 using the processor bus. Such programming code includes an operating system which controls the function and interaction of the various computer components and one or more application programs. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

In the preferred embodiment, the present invention is implemented as one or more computer software programs 111. The implementation of the software of the present invention may operate on a user's workstation, as one or more modules or applications 111 (also referred to as code subroutines, or “objects” in object-oriented programming) which are invoked upon request. Alternatively, the software may operate on a server in a network, or in any device capable of executing the program code implementing the present invention. The logic implementing this invention may be integrated within the code of an application program, or it may be implemented as one or more separate utility modules which are invoked by that application, without deviating from the inventive concepts disclosed herein. The application 111 may be executing in a Web environment, where a Web server provides services in response to requests from a client connected through the Internet. In another embodiment, the application may be executing in a corporate intranet or extranet, or in any other network environment. Configurations for the environment include a client/server network, Peer-to-Peer networks (wherein clients interact directly by performing both client and server function) as well as a multi-tier environment. These environments and configurations are well known in the art.

The implementation of business automation usually is to program according to the logic flow of business process. The customer or end-user profile is used as the conditions for business logic and without further abstraction, adding/modifying a new function would end up as a new development cycle with code reuse. We introduce a novel methodology and framework to allow people to develop applications for business automation over virtual business process environment. The framework is built upon the concept of a state-transformation machine and computational reflection, where the state-transformation defines the logic flow and input/output of business application. Our framework/enabling engine captures the major features of many other business operations. By using this framework, we can have more flexibility of adding new functions for an existing application with only configuration change, and reduce the developing cost of new application.

We will now define technical terms that are going to be used in the text to avoid ambiguity and for the convenience of discussion.

“State” is a unique identifier to present the current status of an end-user. Preferably, state is represented by a multi-dimensional Boolean array. The dimension of the vector is determined as follows:

For a given application, we first find out the critical transition point of the profile, which usually are some well-known conditions for a business domain. Using the online bookstore example, the condition could be the case wherein a customer has bought more than six books. We convert the satisfaction of condition into a TRUE or FALSE Boolean value. Following the same logic, there could be multiple of such conditions. Therefore, an end-user will own a multiple dimensional Boolean result that has the Boolean logic values. We use the collective Boolean values as the state of the end-user. We will see in the definition of state transfer graph, the state is used as the vertex of the graph. Preferably, the creation of the states is accomplished by collaboration between the-domain experts in each application and IT professionals implementing the applications. We use an integer to represent the state based on the binary values of the Boolean vector. For example, a four dimensional vector with values of “TTFF” will be mapped into an integer of 12.

“External business event” is defined as a set of predetermined “events”. An event is usually initiated by the business owner or the end-user himself/herself with respect to a specific end-user. These events will trigger the automation system to either take or not take some actions based on the current states of the user. For example, in the case of an online bookstore, a targeted marketing campaign is a business event. But only the qualified customers will receive real promotions.

“Plug-in method” is defined as a piece of executable code that is used to accomplish the needs of actions. The business action is uniquely determined by the external business event and the current status of the end-user. The executable code will be integrated into our system using a plug-in method. The stub for a specific program language such as C++ or Java will be generated through a parser of the configuration file to help the developers to developing and implementing the plug-in code. The reason of not including the plug-in execution code into our framework is to avoid having application specific code into our framework to allow our code to be application independent. We will see later that the integration is accomplished through the technology called reflection.

“Execution Result” (ER) is a Boolean variable having a value that will represent whether the execution of a method is successful or not. Preferably, it takes only a true or false value to reflect whether the execution was successful or not. For any reasonable-size system, the execution of a method could be “fail”, especially if the execution invokes calls to other systems. To accommodate this possibility and to allow our system to tolerate failures, we introduce the ER variable. We integrate the value ER into our state transfer diagram. After the business action, the end-user state is changed to reflect the new state of the user. Based on the execution result and the current state of the end-user, the next state will be determined and updated. At the same time, the profile might need to be updated. If an application required the update of the end-user profile, the update will be executed by the plug-in method.

“State Transfer Diagram” is the logical flow of program execution, and is preferably expressed as a directed graph. The vertex of the graph represents the valid states of an end-user. As soon as we create all our states, we associate the business events with the states to create a directed graph. The edge of the graph is used to represent the action(s) for the specific state and the associated event. The destination state is uniquely determined by the triggered event, the starting state and the result of the action.

“Minimization of Finite Machine,, is a concept in the computer science to realize a program with least code. After the state transfer diagram is created, the logic execution flow becomes a finite machine. The state transfer diagram can be further simplified using the technique of minimization of finite machine.

“Reflection” is a concept in object-oriented programming language such as Java and C++. With the reflection, the computer program can manipulate objects during runtime. In our framework, the execution flow is defined by state transfer diagram, but real execution code is implemented by the plug-in execution code. Therefore a mapping from the method name of the state transfer diagram to the execution code is required and supported by using the reflection technique.

“Parsing” is the process of parsing the configuration files (Preferably, XML file in our implementation) to generate stub code for the specific computing language such as C++and Java. These configuration files are stored external to the applications thus enabling the developer to change the functionality of the application by changing the configuration files. This reduces the task of coding and recoding applications as and when new features are added or old features removed.

Our multiple layers of abstraction are accomplished as follows. First, an end-user profile is mapped into the multi-dimensional Boolean vector defined above. The vector determines the current state of an end-user. Furthermore, as a consequence of this abstraction, we can store of the application specific state information using the same database design for all applications. Second, the external business events, such as promotion and notification of product delivery, are defined inside a configuration file that is used to create the state-transfer diagram. The execution action (or method call) is a function of the current state and the external business event. The destination state is uniquely determined by the external business event, the initial state and the execution result (ER). Finally, the execution of the application specific action is externalized as a plug-in wrapper using reflection.

The implementation of business automation in the prior art is accomplished by programming according to the logic flow of business process. A customer profile is used as the conditions for business logic. The advantage of this development method is that it is easy for the developers to implement. This method requires less abstraction in the design and implementation phases. The program structure reflects the operation of business. But without further abstraction, adding/modifying a new function would end up as a new programming development cycle.

“Multiple layers of abstraction” of the present invention are preferably accomplished as follows:
First, an end-user profile is mapped into the multi-dimensional Boolean vector defined above. The vector determines the current state of an end-user. Furthermore, as a consequence of this abstraction, we can store the application specific state information using the same database design for all applications.
Second, the external business events, such as promotion and notification of product delivery, are defined inside a configuration file that is used to create the state-transfer diagram. The execution action (or method call) is a function of the current state and the external business event. The destination state is uniquely determined by the external business event, the initial state and the execution result (ER).
Finally, the execution of the application specific action is externalized as a plug-in wrapper using reflection.

The system is composed of following components: an external profile converter to convert the external profile to internal state, a run-time engine to execute the business flow defined by the state-transfer-diagram, and a plug-in wrapper.

To generate the whole program logic code we can use XML configuration files that can be stored as system properties and can be used to populate program code. XML stands for Extensible Markup Language which is a W 3 C initiative that allows encoding of information and services with meaningful structure and semantics so that computers and humans can easily understand. XML is used in the industry for information exchange, and can easily be extended to include user-specified and industry-specified tags. Modifying the XML files can change the application logic and create a whole new application in itself.

Among many possible commercial and non-commercial applications, we choose on-line automated bookstore business as an example. The bookstore system sends promotional information to the customers that satisfy certain criteria based on their previous purchase history. In this application the profile comprises of the purchase history of the customer; the business engagement is the targeted promotion. The action is sending a gift certificate or an offer to the qualified customers. Finally, the profile of a customer will be updated to add the information that the customer has been sent a gift certificate or promotional offer. The result of the action (the customer makes a purchase or not) will change the profile of the customer and this profile will be input for next business event (i.e. if the customer uses the certificate then more promotions can be sent to him/her).

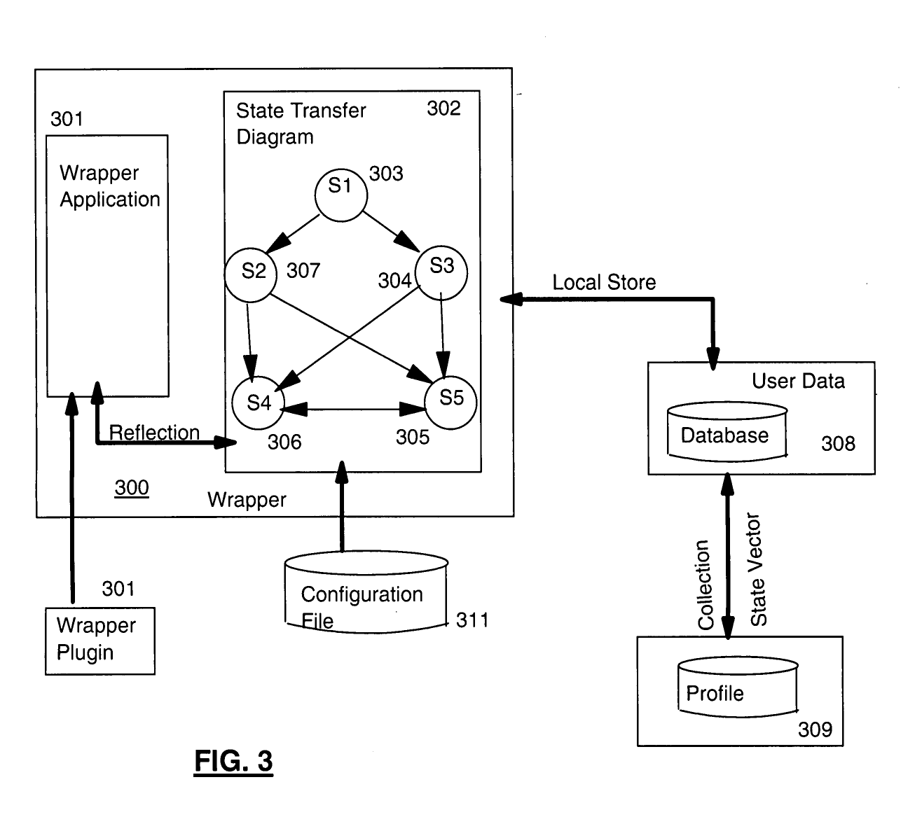

FIG. 3 shows the architecture diagram of our framework. The wrapper application 301 interacts with our framework 300 using programmatic reflection. As soon as the wrapper application 301 starts to talk to the system 302 it will load the configuration files 311 that will create the state transfer diagram. The user state data is stored in the relational database 108 and they are loaded and stored whenever the application requires. The state transfer diagram 302 which specifies the logic flow of the business application, which contains multiple states ( 303, 304, 305, 306, 307 ) and the state transfer direction. The database software 308 is used to store the current state of each end-user which is specified by the profile database instance 309.

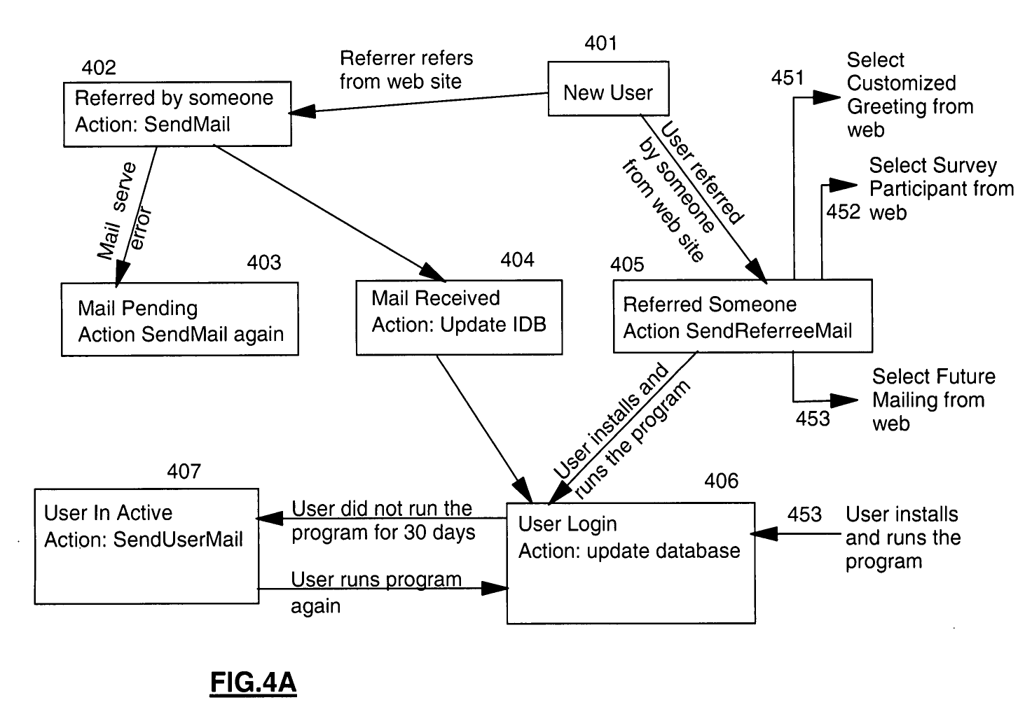

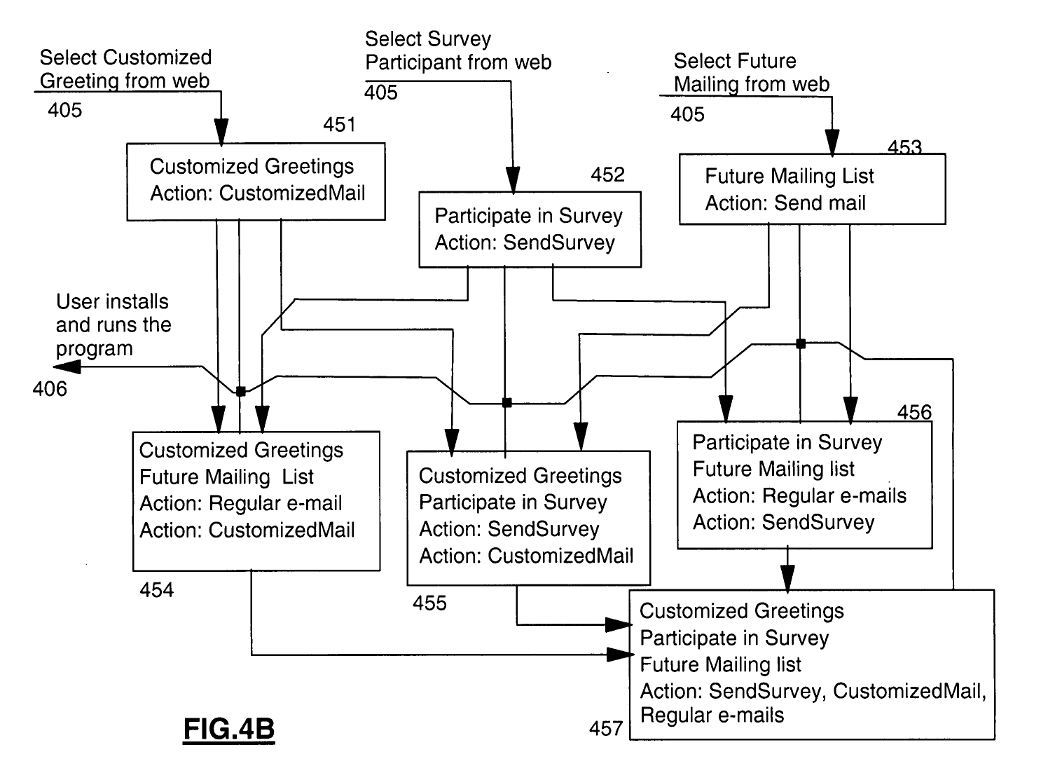

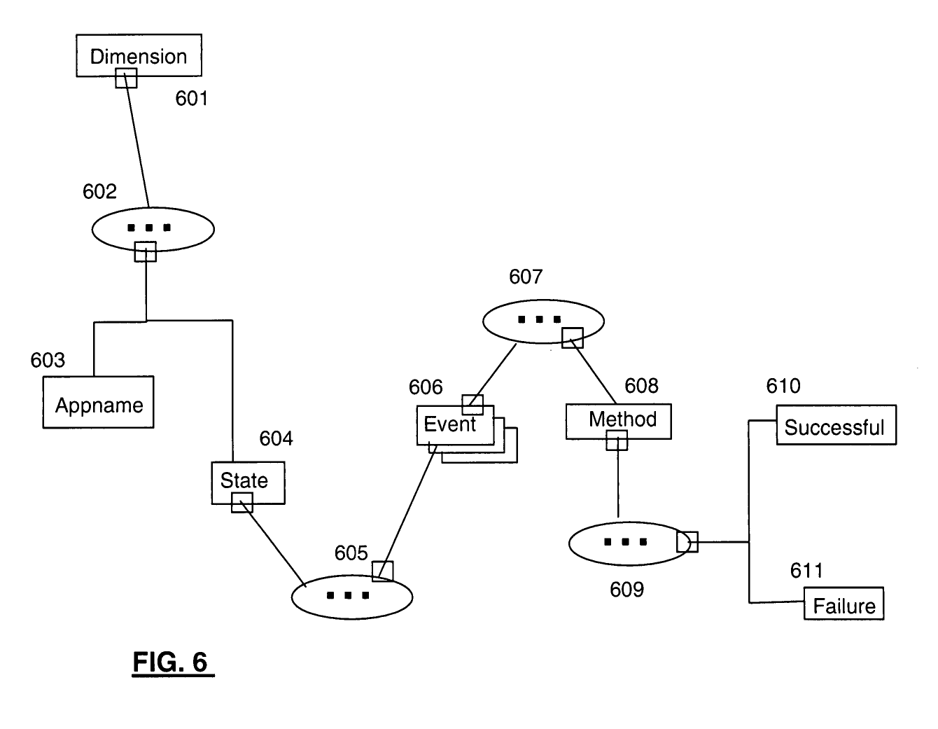

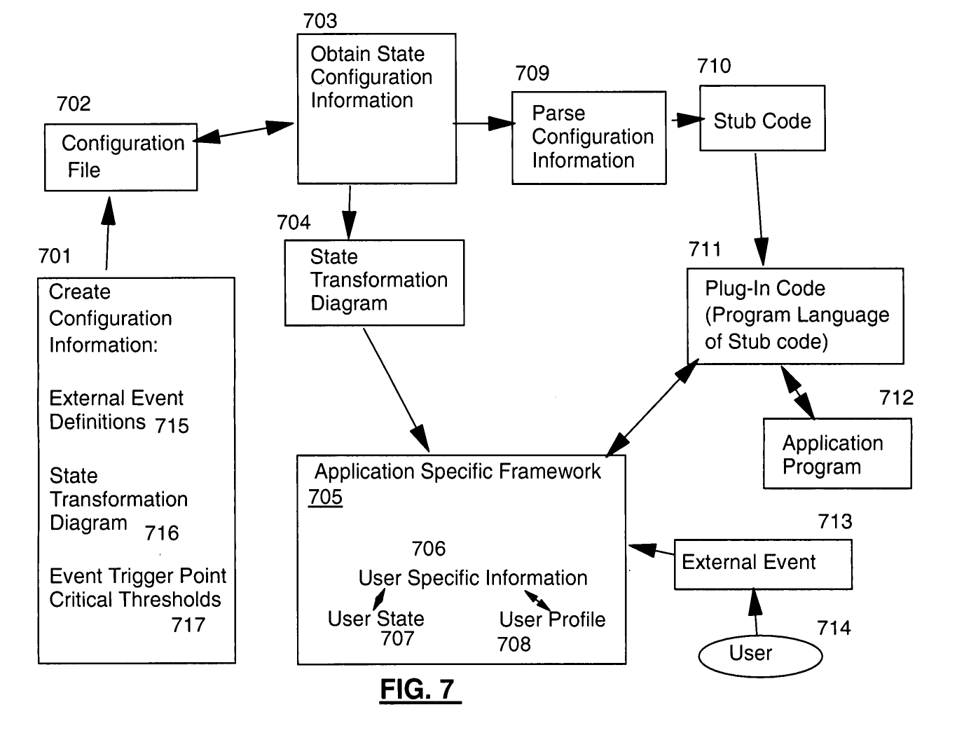

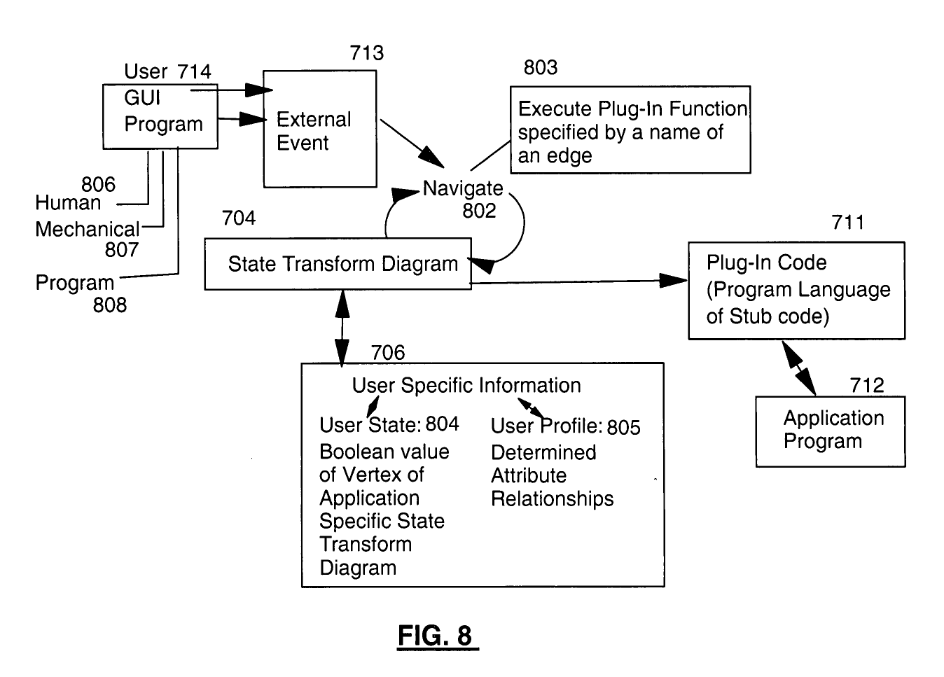

At runtime, when an external business event is triggered for a specific end-user from a person through a GUI or from some other programs, the event is validated against the current state of the state-transfer diagram to check whether it is a valid event for this state. If it is a valid state, the runtime engine (such as a JVM resident in a IBM Webshpere server or Apache Tomcat Application Server) will invoke the corresponding method in the plug-in 301. Both successful and failed execution will result in the state to be updated based on the state-transfer diagram and the new state is stored back into a permanent repository 308. The state transfer diagram is represented using XML. The schema can be found in FIGS. 6. A concrete example is shown in FIGS. 4A-4B (Application of refer-a-friend). Only the plug-in module 301 contains the code for execution of the methods specified by the state-transfer diagram. Preferably interface component 311 provides the interactions between an end-user and the system through a Web interface 312 or other application by way of a Web Service Interface 313.

FIGS. 4A-4B depicts the example of a business application using this framework. The example shows a scenario where a customer of the on-line bookstore (referrer) uses an application to introduce the on-line store to a friend (referee) using a referral system. The basic aim of this application will be to introduce the friend to the services provided by the store with ultimate aim to enable the referrer to earn discounts points whenever the friend makes a purchase or signs up for some service. The diagram shows how the whole system will work. The new user 401 (to the system) can either be a referee or a referrer. In both cases the system first creates a set of state values for the user with initial value 0 that change with the user action. In case that the user was referred by someone, he/she will receive an email from the referrer 404. In case of an email server error it may be delayed 403. After getting the mail the referee can download the software and could become an active user of the software 406. FIGS. 4A-4B provides an example implementation of the state-transfer-diagram 302. For the state-transfer-diagrams presented in FIGS. 4A-4B, each box represents a possible state of an end-user. The transformation from one state to another state is represented by an arrow as a directed edge of the directed graph. A state transformation is triggered by external actions 405 from the web interface of from other applications.

In case the user is a referrer he/she can opt for other options like sending a personalized mail 451, participate in a survey 452 or register to receive future mailing from the software owners 453. The user can select any combination of the 3 options 457. In any case a mail is sent to the referee and he can choose to download the software and use it. In case the user is inactive for a predefined period 407 of time the system will generate a mail as a reminder to the user.

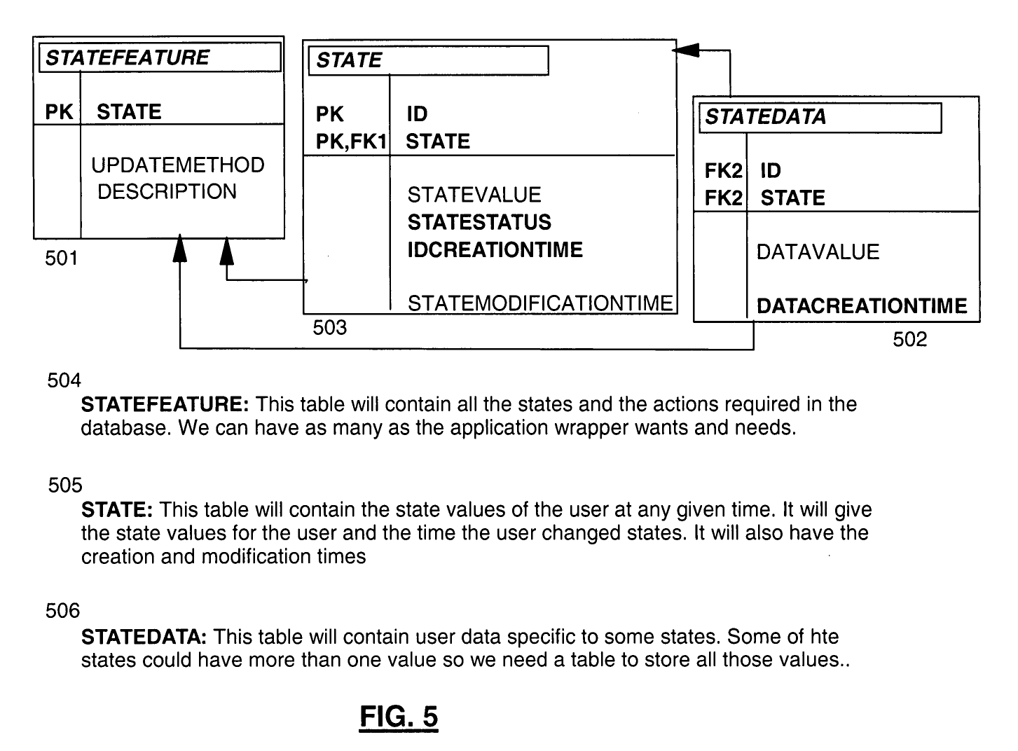

FIG. 5 depicts the storage system for the framework. There are three tables in this system (501, 502, 503). The first stores 301 the number of possible states and the database action associated with the state. For example state 2 can have multiple data associated with it so the database action would be to append. The second 502 and third 503 tables store the state specific values. The third table 503 will store values for states that have multiple entries associated with it like state 2.

FIG. 6 displays the XML schema structure in visual way. This XML scheme specifies the structure of the configuration file of an application in XML has to abide. Each dimension element 601 of the schema can contain one application name 603 and many states 604 (which are pre-defined). There are events 606 defined for the application that have corresponding methods 608. Each method execution 609 takes the user to a different state or new event (610, 611).

This is explained in the representation given below. We discuss a business application called Refer-a-Friend. This is an application used to track the effectiveness of advertising and other promotions of a product by using refer-a-friend technique. The aim is to increase the awareness of a software product (communication tool) and make as many people as possible to use it. The way this works is that the existing users who found the communication tool useful and would like their friends/colleagues to try the tool, refer their friends/colleagues to use this application using our framework. In case the referee has never used the product or has never been referred by another friend, an e-mail would be sent to him/her with all the details of how to install and use it. This information about the referrer and the referee would be stored in the database so as to help track who is being referred by whom. In case the user referred an already referred (referee) friend, an e-mail is sent to the referrer informing the referees status and no e-mail is sent to the referee.

```
<dimension>
  <appname>refer-a-friend</appname>
  <state value=“000000000”>
    <event name=“referredbysomeone”>
      <method value=“sendmail”>
        <successful>
          <nextstate=000100010 nextevent=null>
        </successful>
        <failure>
          <nextstate=000000011
nextevent=“sendmailagain”>
        </failure>
      </method>
    </event>
    <event name=“referredsomeone”>
      <method value=“sendmail”>
        <successful>
          <nextstate=000001000 nextevent=null>
        </successful>
        <failure>
          <nextstate=000001000 nextevent=null>
        </failure>
      </method>
    </event>
  </state>
  <state value=“000000000”>
  .............
  </state>
  </appname>
</dimension>
```

The above representation shows the XML for Refer-a-friend.

Depending on the present state 604 of the user, appropriate events 606 can be triggered. And depending on the outcome 607 of the event the user will move to the next allowed state (610, 611). The user state is represented in bits. Each bit represents a state for the user. When the user triggers events, this state bit changes. As shown the user is in the initial state of 000000000. The user can either refer someone or someone can refer him/her. In case the user was referred by someone, he will go into state 000100010 if successful or state 000000011 if unsuccessful. Another event is triggered (send_mail_again) in case of failure. Started from right to left, the definition of each bit of the state is
1 bit=Email not Sent
2 bit=Referred by Someone
3 bit=Login User
4 bit=Referred someone
5 bit=Not Active for a month
6 bit=Email sent
7 bit=Customized Greetings to the referee
8 bit=Want to answer questionnaire list
9 bit=Future Mail list and marketing

This XML can be stored as proprietary files and can be used to populate the application code. If the application requires a new set of actions for the same event, all that needs to be done is change the XML event action. Any change in the XML can change the functionality of the whole application without any efforts to change the program logic code. Re-defining the states and changing the event actions in the XML will create an entirely different new application.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment of the invention has been illustrated and described herein, it is to be understood that the invention is not limited to the precise construction herein disclosed, and the right is “reserved” to all changes and modifications coming within the scope of the invention as defined in the appended claims.

What is claimed is:

1. A computer implemented method for generating an application specific framework, the method comprising the steps of:
a) creating the application specific framework from configuration information, the application specific framework comprising an external event interface for receiving external events, a configuration file interface for receiving configuration information, an application specific plug-in code for interfacing with application programs, user state storage and user profile storage;
b) the created application specific framework obtaining user specific information about one or more users, the user specific information comprising profile information about a respective user and current user state of the respective user;
c) the created application specific framework, responsive to an external event, navigating the state transformation diagram from the current user state to a new current user state, the navigation based on the user specific information;
d) saving the new current user state as the current user state;
e) responsive to the navigating step invoking a corresponding function via the derived application specific plug-in code; and
f) repeating steps c) through e) for subsequent external events.

2. The method according to claim 1, comprising the further steps of:
a.1) obtaining the configuration information from the configuration file, the configuration information comprising a state transformation diagram for the application specific framework;
a.2) deriving the application specific plug-in code from the obtained configuration information, the application specific plug-in code comprising functions for supporting application specific requirements;

3. The method according to claim 2, wherein the deriving application specific plug-in code step comprises the steps of:
a.2.1) parsing the configuration information to create stub code for interfacing the application specific framework with one or more application programs; and
a.2.2) implementing the stub code as the application specific plug-in using the programming language of the stub code.

4. The method according to claim 1, wherein, responsive to the external event, step c) comprises selecting the new current user state from a plurality of user states based on any one of the current user state, the external event or the configuration information.

5. The method according to claim 1, comprising the further step of:
creating the configuration information, wherein the configuration information comprises any one of external event definitions or the state transformation diagram; and
saving the configuration information in the configuration file.

6. The method according to claim 5, wherein the external event definitions comprise event trigger points, the event trigger points comprising critical thresholds.

7. The method according to claim 2, wherein the obtained state transformation diagram comprises a directed graph having a set of logic vector array values, the logic vector array values presenting a vertex of the graph of the obtained state transformation diagram.

8. The method according to claim 1, wherein a user state is presented as a current logic vector array Boolean value presented by a vertex of the application specific state transformation diagram, wherein the navigating the state transformation diagram step comprises the further step of executing functions specified by a name of an edge of the state transformation diagram in the plug-in code.

9. The method according to claim 1, comprising the further steps of:
determining a relationship of attributes of the profile information;
providing the determined relationship of attributes as the user specific information for the navigation step.

10. The method according to claim 3, wherein the parsing to create stub code step comprises creating any one of Java stub code, C++ stub code or a general-purpose language selected for creating the plug-in code.

11. The method according to claim 1, wherein the user comprises any one of a GUI interface to a human user, a computer program responding to a mechanical event, or a computer program responding to a program event.

12. A computer program product for generating an application specific framework, the computer program product comprising:
a storage medium readable by a processing circuit and storing instructions for execution by the processing circuit for performing a method comprising:
a) creating the application specific framework from configuration information, the application specific framework comprising an external event interface for receiving external events, a configuration file interface for receiving configuration information, an application specific plug-in code for interfacing with application programs, user state storage and user profile storage;
b) the created application specific framework obtaining user specific information about one or more users, the user specific information comprising profile information about a respective user and current user state of the respective user;
c) the created application specific framework, responsive to an external event, navigating the state transformation diagram from the current user state to a new current user state, the navigation based on the user specific information;
d) saving the new current user state as the current user state;
e) responsive to the navigating step invoking a corresponding function via the derived application specific plug-in code; and
f) repeating steps c) through e) for subsequent external events.

13. The computer program product according to claim 12, comprising the further steps of:
a.1) obtaining the configuration information from the configuration file, the configuration information comprising a state transformation diagram for the application specific framework;
a.2) deriving the application specific plug-in code from the obtained configuration information, the application specific plug-in code comprising functions for supporting application specific requirements;

14. The computer program product according to claim 13, wherein the deriving application specific plug-in code step comprises the steps of:
a.2.1) parsing the configuration information to create stub code for interfacing the application specific framework with one or more application programs; and
a.2.2) implementing the stub code as the application specific plug-in using the programming language of the stub code.

15. The computer program product according to claim 12, comprising the further step of:
creating the configuration information, wherein the configuration information comprises any one of external event definitions or the state transformation diagram; and
saving the configuration information in the configuration file.

16. The computer program product according to claim 12, comprising the further steps of:
determining a relationship of attributes of the profile information;
providing the determined relationship of attributes as the user specific information for the navigation step.

17. A system for generating an application specific framework, the system comprising:
a main store;
a network;
a processor in communications with the main store the network wherein the system includes instructions to execute a method comprising the steps of:
a) creating the application specific framework from configuration information, the application specific framework comprising an external event interface for receiving external events, a configuration file interface for receiving configuration information, an application specific plug-in code for interfacing with application programs, user state storage and user profile storage;
b) the created application specific framework obtaining user specific information about one or more users, the user specific information comprising profile information about a respective user and current user state of the respective user;
c) the created application specific framework, responsive to an external event, navigating the state transformation diagram from the current user state to a new current user state, the navigation based on the user specific information;
d) saving the new current user state as the current user state;
e) responsive to the navigating step invoking a corresponding function via the derived application specific plug-in code; and
f) repeating steps c) through e) for subsequent external events.

18. The system according to claim 17, comprising the further steps of:
a.1) obtaining the configuration information from the configuration file, the configuration information comprising a state transformation diagram for the application specific framework;
a.2) deriving the application specific plug-in code from the obtained configuration information, the application specific plug-in code comprising functions for supporting application specific requirements;

19. The system according to claim 18, wherein the deriving application specific plug-in code step comprises the steps of:
a.2.1) parsing the configuration information to create stub code for interfacing the application specific framework with one or more application programs; and
a.2.2) implementing the stub code as the application specific plug-in using the programming language of the stub code.

20. The system according to claim 12, comprising the further steps of:
determining a relationship of attributes of the profile information;
providing the determined relationship of attributes as the user specific information for the navigation step.
